(19) United States
(12) Patent Application Publication
(10) Pub. No.: US 2025/0242644 A1
(43) Pub. Date: Jul. 31, 2025

(54) Locking Glad Hand Device

(71) Applicant: Kevin Schmidt, Depere, WI (US)

(72) Inventor: Kevin Schmidt, Depere, WI (US)

(21) Appl. No.: 18/424,418

(22) Filed: Jan. 26, 2024

(51) Int. Cl. B60D 1/64

(52) U.S. Cl. CPC B60D 1/64

(57) ABSTRACT

A locking glad hand device includes a glad hand coupler that is removably attachable to a glad hand fitting on a tail end of an air brake line. A locking pin is movably disposed on the glad handle coupler which engages a respective wing on the glad hand fitting thereby inhibiting the glad hand coupler from being tampered with and potentially disabling the air brake system of the tractor trailer. A lock is rotatably disposed on the glad hand coupler. The lock engages the locking pin when the locking pin is urged into a locking condition and the lock is rotated into a locking position thereby locking the glad hand coupler to the glad hand fitting. Conversely, the lock disengages the locking pin when the lock is rotated into an unlocking position thereby facilitating the locking pin to be biased into the releasing condition.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to glad hand devices and more particularly pertains to a new glad hand device for locking a glad hand coupler to a glad hand fitting. The device includes a glad hand coupler that includes a locking pin and a lock. The locking pin is urgeable into a locking condition when the glad hand coupler is fitted to the glad hand fitting to inhibit the glad hand coupler from being unfitted from the glad hand fitting. The device includes a lock integrated into the glad hand coupler which engages the locking pin to retain the locking pin in the locking condition thereby securing the glad hand coupler to the glad hand fitting.

### (2) Description of Related Art Including Information Disclosed Under 37 CFR 1.97 and 1.98

The prior art relates to glad hand devices including a variety of glad hand coupler devices which each has a lock for locking the glad hand coupler to a glad hand fitting and a variety of glad hand lock devices which each at least includes a locking mechanism that is attachable to a glad hand coupler for securing the glad hand coupler to a glad hand fitting and a glad hand security device that includes a cover that is lockable over a glad hand coupler to restrict use of the glad hand coupler. In no instance does the prior art disclose a lockable glad hand coupler device that includes a glad hand and a locking pin that is urgeable into a locking condition which engages a glad hand fitting and a lock that engages the locking pin to inhibit the locking pin from disengaging the glad hand fitting for securing the glad hand coupler to the glad hand fitting.

### BRIEF SUMMARY OF THE INVENTION

An embodiment of the disclosure meets the needs presented above by generally comprising a glad hand coupler that is removably attachable to a glad hand fitting on a tail end of an air brake line. A locking pin is movably disposed on the glad handle coupler which engages a respective wing on the glad hand fitting thereby inhibiting the glad hand coupler from being tampered with and potentially disabling the air brake system of the tractor trailer. A lock is rotatably disposed on the glad hand coupler. The lock engages the locking pin when the locking pin is urged into a locking condition and the lock is rotated into a locking position thereby locking the glad hand coupler to the glad hand fitting. Conversely, the lock disengages the locking pin when the lock is rotated into an unlocking position thereby facilitating the locking pin to be biased into the releasing condition.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top view of a locking glad hand device according to an embodiment of the disclosure.

FIG. 2 is a bottom view of an embodiment of the disclosure.

FIG. 3 is a left side phantom view of an embodiment of the disclosure.

FIG. 4 is a top view of an embodiment of the disclosure.

FIG. 5 is a perspective in-use view of an embodiment of the disclosure.

### DETAILED DESCRIPTION OF THE INVENTION

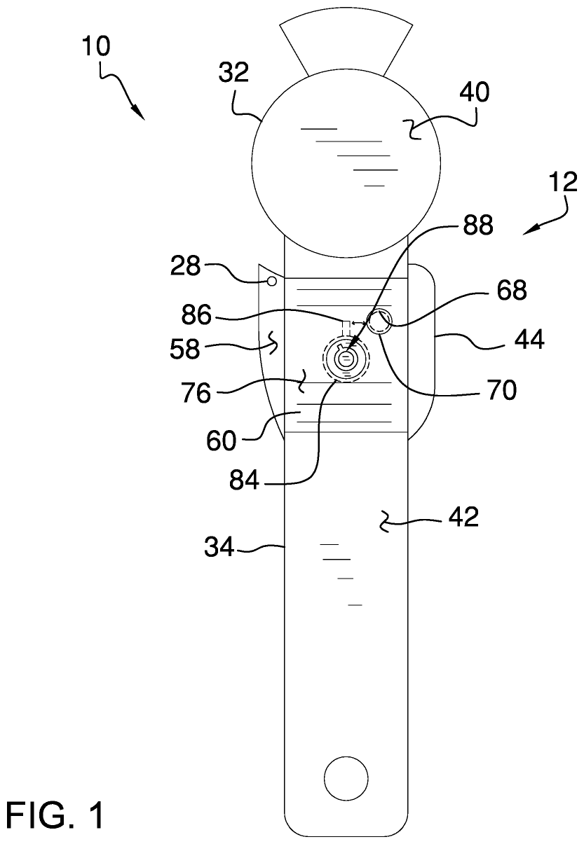

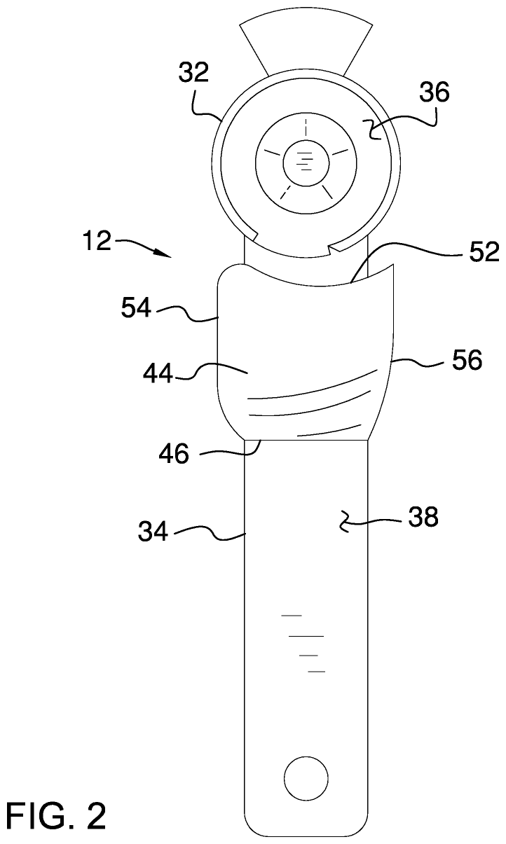

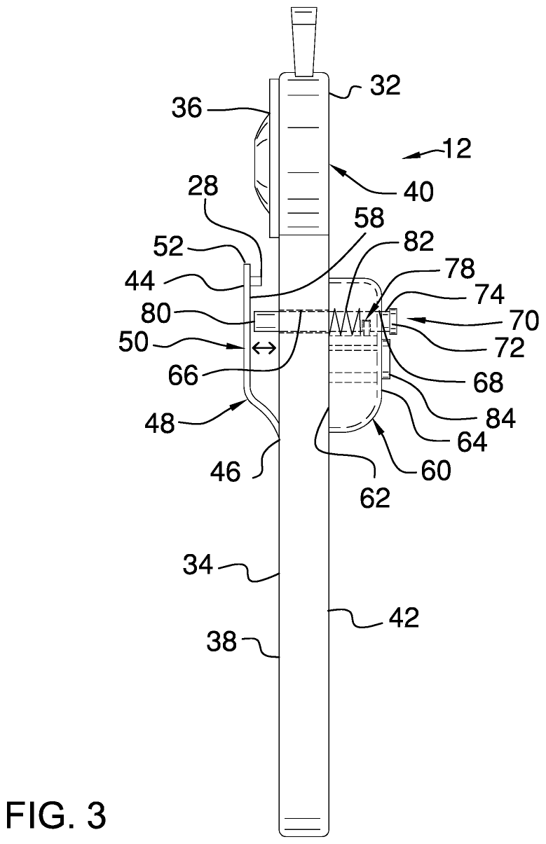

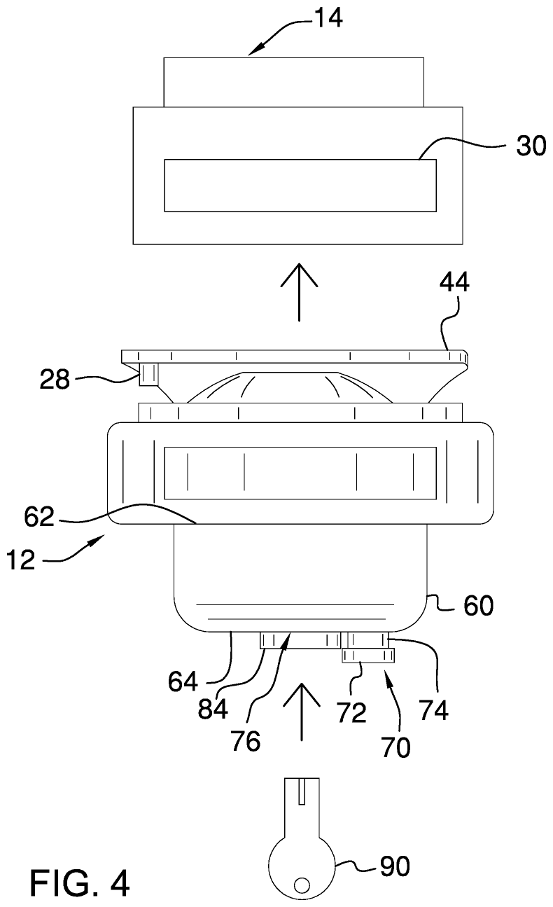

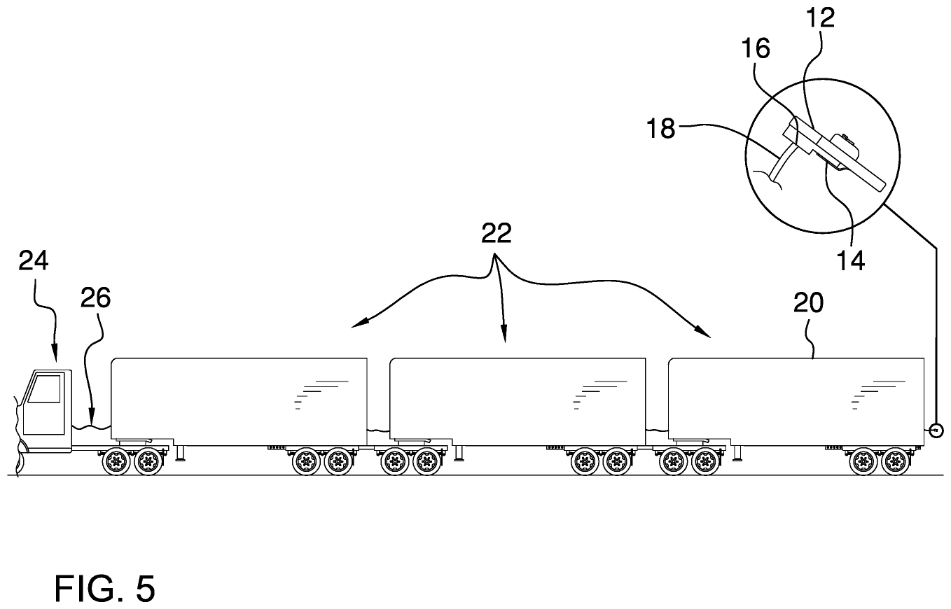

With reference now to the drawings, and in particular to FIGS. 1 through 5 thereof, a new glad hand device embodying the principles and concepts of an embodiment of the disclosure and generally designated by the reference numeral 10 will be described.

As best illustrated in FIGS. 1 through 5, the locking glad hand device 10 generally comprises a glad hand coupler 12 that is removably attachable to a glad hand fitting 14 on a tail end 16 of an air brake line 18 on a tail trailer 20 of a set of trailers 22 that are being towed by a semi tractor 24. The glad hand coupler 12 facilitates continuous air flow throughout an air brake system 26 of the semi tractor 24 and the set of trailers 22 while the set of trailers 22 is being towed. Additionally, the glad hand coupler 12 replaces conventional dummy glad hand couplers that are currently employed on the tail end of the air brake line of the tail trailers. The glad hand fitting 14 on the tail end 16 of the air brake line 18 may be a glad hand fitting of any conventional design that is commonly employed on over-the-road cargo trailers which employ air brakes, including but not being limited to refrigerator trailers and flatbed trailers.

The glad hand coupler 12 includes all of the hardware typically associated with existing glad hand couplers, including a set pin 28 which abuts a respective side of a wing 30 on the glad hand fitting 14 when the glad hand coupler 12 is fitted to the glad hand fitting 14 for inhibiting the glad hand coupler 12 from rotating in a first direction on the glad hand fitting 14. The glad hand coupler 12 has a head 32 and a handle 34 extending away from the head 32; the head 32 has a first surface 36 that is aligned with a primary surface 38 of the handle 34 and the head 32 has a second surface 40 is aligned with a secondary surface 42 of the handle 34. The glad hand coupler 12 has a first shield 44 which has a lower edge 46 that is coupled to the primary surface 38 of the handle 34. The first shield 44 has a bend 48 which is spaced from and is oriented parallel to the lower edge 46 to define a spaced portion 50 of the first shield 44 which is spaced from and lies on a plane oriented parallel to the primary surface 38 of the handle 34.

The first shield 44 has an upper edge 52 which curves downwardly between a first lateral edge 54 and a second lateral edge 56 of the first shield 44. An intersection between the first lateral edge 54 and the upper edge 52 is rounded and an intersection between the second lateral edge 56 and the upper edge tapers 52 to a point. The set pin 28 is coupled to and extends away from a rear surface 58 of the spaced portion 50 of the first shield 44 such that the set pin 28 is directed toward the primary surface 38 of the handle 34. Additionally, the set pin 28 is located proximate the intersection between the second lateral edge 56 and the upper edge 52 of the first shield 44.

The glad hand coupler 12 has a second shield 60 which has a perimeter edge 62 that is coupled to the secondary surface 42 of the handle 34. The second shield 60 has a rear wall 64 which is spaced from and lies on a plane is oriented parallel to the secondary surface 42 of the handle 34. Additionally, the second shield 60 is aligned with the first shield 44. The handle 34 has an aperture 66 which extends through the primary surface 38 and the secondary surface 42. The aperture 66 is aligned with the first shield 44 and the second shield 60; the aperture 66 is offset from a longitudinal centerline of the handle 34. The second shield 60 has an aperture 68 extending through the rear wall 64 and the aperture 68 in the rear wall 64 is aligned with the aperture 66 in the handle 34.

A locking pin 70 is movably disposed on the glad handle 34 coupler and the locking pin 70 is biased into a releasing condition. The locking pin 70 is urgeable into a locking condition when the glad hand coupler 12 is removably attached to the glad hand fitting 14. Furthermore, the locking pin 70 abuts an opposing side of the wing 30 on the glad hand fitting 14 with respect to the set pin 28 when the glad hand coupler 12 is fitted to the glad hand fitting 14. In this way the glad hand coupler 12 is inhibited from rotating in a second direction on the glad hand fitting 14. Furthermore, the set pin 28 and the locking pin 70, in conjunction with each other, inhibit the glad hand coupler 12 from being rotated in any direction when the glad hand coupler 12 is fitted to the glad hand fitting 14. Thus, the locking pin 70 inhibits the glad hand coupler 12 from being tampered with and potentially disabling the air brake system 26 of the tractor trailer.

The locking pin 70 comprises a head 72 and a stem 74. The stem 74 extends through the aperture 68 in the rear wall 64 of the second shield 60 and the aperture 66 in the handle 34 having the head 72 being spaced from an outwardly facing surface 76 of the rear wall 64. In this way the head 72 can be depressed to urge the locking pin 70 into the locking condition. Furthermore, the stem 74 has a notch 78 which is recessed into the stem 74 and the notch 78 is positioned closer to the head 72 than a distal end 80 of the stem 74.

A biasing member 82 is provided and the biasing member 82 is positioned around the stem 74 of the locking pin 70. The biasing member 82 extends between the notch 78 in the stem 74 and the secondary surface 42 of the handle 34 for biasing the locking pin 70 into the releasing condition. The distal end 80 of the stem 74 is aligned with the primary surface 38 of the handle 34 when the locking pin 70 is in the releasing condition. Conversely, the stem 74 travels through the handle 34 having the distal end 80 being spaced from the primary surface 38 of the handle 34 when the locking pin 70 is urged into the locking condition.

A lock 84 is provided and the lock 84 is rotatably disposed on the glad hand coupler 12. The lock 84 engages the locking pin 70 when the locking pin 70 is urged into the locking condition and the lock 84 is rotated into a locking position. In this way the glad hand coupler 12 is locked to the glad hand fitting 14. The lock 84 disengages the locking pin 70 when the lock 84 is rotated into an unlocking position thereby facilitating the locking pin 70 to be biased into the releasing condition. In this way the glad hand coupler 12 can be removed from the glad hand fitting 14.

The lock 84 is rotatably integrated into the rear wall 64 of the second shield 60 and the lock 84 has a finger 86 which extends laterally away from the lock 84 such that the finger 86 is positioned between the rear wall 64 of the second shield 60 and the secondary surface 42 of the handle 34. The finger 86 extends into the notch 78 in the stem 74 of the locking pin 70 when the locking pin 70 is urged into the locking condition and the lock 84 is rotated into the locking position. Conversely, the finger 86 is displaced from the notch 78 when the lock 84 is rotated into the unlocking position. The lock 84 has a keyhole 88 which is exposed with respect to the rear wall 64 of the second shield 60 for insertably receiving a key 90 for rotating the lock 84 between the locking position and the unlocking position. Furthermore, the lock 84 is inhibited from being rotated between the locking position and the unlocking position when the key 90 is not inserted into the keyhole 88.

In use, the glad hand coupler 12 is fitted to the glad hand fitting 14 on the tail end 16 of the air brake line 18 on the tail trailer 20 of the set of trailers 22. The glad hand coupler 12 is rotated into a locked position such that the set pin 28 engages the respective wing 30 in the glad hand fitting 14. The locking pin 70 is urged into the locking condition and the key 90 is inserted into the keyhole 88 to rotate the lock 84 into the locking position. In this way each of the set pin 28 and the locking pin 70 engage the glad hand fitting 14 thereby inhibiting the glad hand coupler 12 from being uncoupled from the glad hand fitting 14. Thus, the air brake system 26 of the set of trailers 22 and the semi tractor 24 are facilitated to operate normally while the semi tractor 24 is towing the set of trailers 22. Furthermore, the lock 84 and the locking pin 70 inhibit the glad hand coupler 12 from being tampered with while the semi tractor 24 is stopped at a traffic signal, for example, which could potentially disable the air brake system 26 of the semi tractor 24 and the set of trailers 22.

With respect to the above description then, it is to be realized that the optimum dimensional relationships for the parts of an embodiment enabled by the disclosure, to include variations in size, materials, shape, form, function and manner of operation, device and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A locking glad hand device for inhibiting air pressure loss in an air brake system on a tractor trailer, said device comprising:
a glad hand coupler being removably attachable to a glad hand fitting on a tail end of an air brake line on a tail trailer of a set of trailers that are being towed by a semi tractor thereby facilitating continuous air flow throughout an air brake system of said semi tractor and said set of trailers, said glad hand coupler including a set pin which abuts a respective side of a wing on said glad hand fitting when said glad hand coupler is fitted to said glad hand fitting for inhibiting said glad hand coupler from rotating in a first direction on said glad hand fitting;
a locking pin being movably disposed on said glad handle coupler, said locking pin being biased into a releasing condition, said locking pin being urgeable into a locking condition when said glad hand coupler is removably attached to said glad hand fitting having said locking pin abutting an opposing side of said wing on said glad hand fitting with respect to said set pin when said glad hand coupler is fitted to said glad hand fitting thereby inhibiting said glad hand coupler from rotating in a second direction on said glad hand fitting wherein said locking pin is configured to inhibit said glad hand coupler from being tampered with and potentially disabling said air brake system of said tractor trailer; and
a lock being rotatably disposed on said glad hand coupler, said lock engaging said locking pin when said locking pin is urged into said locking condition and said lock is rotated into a locking position thereby locking said glad hand coupler to said glad hand fitting, said lock disengaging said locking pin when said lock is rotated into an unlocking position thereby facilitating said locking pin to be biased into said releasing condition such that said glad hand coupler is removable from said glad hand fitting.

2. The device according to claim 1, wherein:
said glad hand coupler has a head and a handle extending away from said head;
said head has a first surface being aligned with a primary surface of said handle;
said head has a second surface being aligned with a secondary surface of said handle;
said glad hand coupler has a first shield which has a lower edge being coupled to said primary surface of said handle;
said first shield has a bend being spaced from and being oriented parallel to said lower edge to define a spaced portion of said first shield being spaced from and lying on a plane oriented parallel to said primary surface of said handle;
said first shield has an upper edge curving downwardly between a first lateral edge and a second lateral edge of said first shield;
an intersection between said first lateral edge and said upper edge is rounded;
an intersection between said second lateral edge and said upper edge tapers to a point;
said set pin is coupled to and extends away from a rear surface of said spaced portion of said first shield such that said set pin is directed toward said primary surface of said handle;
said set pin is located proximate said intersection between said second lateral edge and said upper edge of said first shield;
said glad hand coupler has a second shield having a perimeter edge being coupled to said secondary surface of said handle;
said second shield has a rear wall being spaced from and lying on a plane being oriented parallel to said secondary surface of said handle; and
said second shield is aligned with said first shield.

3. The device according to claim 2, wherein:
said handle has an aperture extending through said primary surface and said secondary surface;
said aperture is aligned with said first shield and said second shield; and
said aperture is offset from a longitudinal centerline of said handle.

4. The device according to claim 3, wherein:
said second shield has an aperture extending through said rear wall; and
said aperture in said rear wall is aligned with said aperture in said handle.

5. The device according to claim 4, wherein:
said locking pin comprises a head and a stem; and
said stem extends through said aperture in said rear wall of said second shield and said aperture in said handle having said head being spaced from an outwardly facing surface of said rear wall thereby facilitating said head to be depressed to urge said locking pin into said locking condition.

6. The device according to claim 5, wherein:
said stem has a notch being recessed into said stem; and
said notch is positioned closer to said head than a distal end of said stem.

7. The device according to claim 6, wherein:
said device includes a biasing member being positioned around said stem of said locking pin; and
said biasing member extends between said notch in said stem and said secondary surface of said handle for biasing said locking pin into said releasing condition.

8. The device according to claim 5, wherein:
said distal end of said stem is aligned with said primary surface of said handle when said locking pin is in said releasing condition; and
said stem travels through said handle having said distal end being spaced from said primary surface of said handle when said locking pin is urged into said locking condition.

9. The device according to claim 6, wherein:
said lock is rotatably integrated into said rear wall of said second shield;
said lock has a finger extending laterally away from said lock such that said finger is positioned between said rear wall of said second shield and said secondary surface of said handle;
said finger extends into said notch in said stem of said locking pin when said locking pin is urged into said locking condition and said lock is rotated into said locking position;
said finger is displaced from said notch when said lock is rotated into said unlocking position;
said lock has a keyhole being exposed with respect to said rear wall of said second shield for insertably receiving a key for rotating said lock between said locking position and said unlocking position; and
said lock is inhibited from being rotated between said locking position and said unlocking position when said key is not inserted into said keyhole.

10. A locking glad hand device for inhibiting air pressure loss in an air brake system on a tractor trailer, said device comprising:
a glad hand coupler being removably attachable to a glad hand fitting on a tail end of an air brake line on a tail trailer of a set of trailers that are being towed by a semi tractor thereby facilitating continuous air flow throughout an air brake system of said semi tractor and said set of trailers, said glad hand coupler including a set pin which abuts a respective side of a wing on said glad hand fitting when said glad hand coupler is fitted to said glad hand fitting for inhibiting said glad hand coupler from rotating in a first direction on said glad hand fitting, said glad hand coupler having a head and a handle extending away from said head, said head having a first surface being aligned with a primary surface of said handle, said head having a second surface being aligned with a secondary surface of said handle, said glad hand coupler having a first shield which has a lower edge being coupled to said primary surface of said handle, said first shield having a bend being spaced from and being oriented parallel to said lower edge to define a spaced portion of said first shield being spaced from and lying on a plane oriented parallel to said primary surface of said handle, said first shield having an upper edge curving downwardly between a first lateral edge and a second lateral edge of said first shield, an intersection between said first lateral edge and said upper edge being rounded, an intersection between said second lateral edge and said upper edge tapering to a point, said set pin being coupled to and extending away from a rear surface of said spaced portion of said shield such that said set pin is directed toward said primary surface of said handle, said set pin being located proximate said intersection between said second lateral edge and said upper edge of said first shield, said glad hand coupler having a second shield having a perimeter edge being coupled to said secondary surface of said handle, said second shield having a rear wall being spaced from and lying on a plane being oriented parallel to said secondary surface of said handle, said second shield being aligned with said first shield, said handle having an aperture extending through said primary surface and said secondary surface, said aperture being aligned with said first shield and said second shield, said aperture being offset from a longitudinal centerline of said handle, said second shield having an aperture extending through said rear wall, said aperture in said rear wall being aligned with said aperture in said handle;
a locking pin being movably disposed on said glad handle coupler, said locking pin being biased into a releasing condition, said locking pin being urgeable into a locking condition when said glad hand coupler is removably attached to said glad hand fitting having said locking pin abutting an opposing side of said wing on said glad hand fitting with respect to said set pin when said glad hand coupler is fitted to said glad hand fitting thereby inhibiting said glad hand coupler from rotating in a second direction on said glad hand fitting wherein said locking pin is configured to inhibit said glad hand coupler from being tampered with and potentially disabling said air brake system of said tractor trailer, said locking pin comprising head and a stem, said stem extending through said aperture in said rear wall of said second shield and said aperture in said handle having said head being spaced from an outwardly facing surface of said rear wall thereby facilitating said head to be depressed to urge said locking pin into said locking condition, said stem having a notch being recessed into said stem, said notch being positioned closer to said head than a distal end of said stem;
a biasing member being positioned around said stem of said locking pin, said biasing member extending between said notch in said stem and said secondary surface of said handle for biasing said locking pin into said releasing condition, said distal end of said stem being aligned with said primary surface of said handle when said locking pin is in said releasing condition, said stem traveling through said handle having said distal end being spaced from said primary surface of said handle when said locking pin is urged into said locking condition; and
a lock being rotatably disposed on said glad hand coupler, said lock engaging said locking pin when said locking pin is urged into said locking condition and said lock is rotated into a locking position thereby locking said glad hand coupler to said glad hand fitting, said lock disengaging said locking pin when said lock is rotated into an unlocking position thereby facilitating said locking pin to be biased into said releasing condition such that said glad hand coupler is removable from said glad hand fitting, said lock being rotatably integrated into said rear wall of said second shield, said lock having a finger extending laterally away from said lock such that said finger is positioned between said rear wall of said second shield and said secondary surface of said handle, said finger extending into said notch in said stem of said locking pin when said locking pin is urged into said locking condition and said lock is rotated into said locking position, said finger being displaced from said notch when said lock is rotated into said unlocking position, said lock having a keyhole being exposed with respect to said rear wall of said second shield for insertably receiving a key for rotating said lock between said locking position and said unlocking position, said lock being inhibited from being rotated between said locking position and said unlocking position when said key is not inserted into said keyhole.
